(19) United States
(12) Patent Application Publication
(10) Pub. No.: US 2002/0065759 A1
(43) Pub. Date: May 30, 2002

(54) Automatically processing user requests for supplier services subject to excess demand using a flexible market based mechanism - systems, methods and program products

(76) Inventors: Stephen J. Boies, Mahopac, NY (US); Samuel Dinkin, Austin, TX (US); David Greene, Ossining, NY (US); Paul Andrew Moskowitz, Yorktown Heights, NY (US); Philip Shi-Lung Yu, Chappaqua, NY (US)

Correspondence Address: MORGAN & FINNEGAN, L.L.P., 345 Park Avenue, New York, NY, 10154, US

(21) Appl. No.: 09/725,170

(22) Filed: Nov. 29, 2000

(51) Int. Cl. G06F 17/60; G06F 15/16

(52) U.S. Cl. 705/37; 705/8; 709/217

(57) ABSTRACT

A system, method and program product automatically processes user requests for services subject to excess demand using a flexible market based mechanism. A coordinating server automatically manages a plurality of users in obtaining desired services from a plurality of service providers. The server is seamlessly coupled to the users and the service provider(s) via a network, e.g. Internet, PSTN, Wireless, Cable, Satellite. Each service provider maintains a queue of service requests in process. The service provider may also maintain multiple queues for lower levels of service, service priority, etc. Each user service request is provided to the server via the network as a competitive offer for the desired service. Where the current price, terms, conditions for the service are beyond the users bid, the user bid may opt to be disconnected from the server. Alternatively, the user bid may request the service provider to call back or provide the user with an appointment for call back by the service provider. The server selects the user providing the highest and best bid for entrance into the service provider queue and transmit to the selected user a token as evidence of the successful offer, after payment of the offer price. The payment may be made by another in behalf of the winning user, provided the payer has a good standing with the server. The user presents the token to the service provider at the time the services become available, which may be in real time or downloaded to the user in the case of software, video, audio, etc. The user may offer the service provider a special payment to reduce the queuing time by being assigned to the priority queue. Alternatively, a lesser delivery of service may be made by the service provider at the option of the user or the service provider, which would entail a payment from the service provider to the user.

### BACKGROUND OF THE INVENTION

1. Field of Invention

This invention relates to e-commerce systems, methods and program products. More particularly, the invention relates to automatically processing user requests for supplier services subject to excess demand using a flexible market based mechanism.

2. Description of Prior Art

Where services or goods are in short supply, users are served on a first come first served basis since all users offer the same price and accept the same terms and conditions for the goods or services. Yet, many users may be willing to offer a higher price and/or accept other supplier terms and conditions for such goods or services, to obtain them with the least delay or at a time more appropriate for their situation. What is needed in the art, where excess demand exists, is a flexible marketing mechanism which enables users to compete for services and goods on a free market basis to complement a first come—first served basis.

Prior art related to marketing systems for goods and services includes:

U.S. Pat. No. 6,101,484 discloses a dynamic market equilibrium management system especially adapted for the sale of goods and services through an online buying group (referred to herein as a “co-op”) formed for the specific purpose of purchasing a particular product at (102) by defining a start time, end time, critical mass, any minimum number of units offered, any maximum number of units offered, starting price and product cost curve. As data is gathered from buyers, by means of their making binding purchase offers, the co-op is modified at (108) using the market equilibrium manager, so as to take into account market forces such as supply and demand for the item to be sold and their interrelationship with the purchase price for such item. When used with the online buying group, the dynamic market equilibrium management system permits dynamic, real-time yield management decisions based on true market data. A graphical user interface receives user inputs for directly manipulating graphical display of data from a database on a display device and displays feedback dependent variable data on the display device, such as in the form of a changed numerical value in response to the user moving at least one data point in the graphical display.

U.S. Pat. No. 5,826,244 discloses a system and method to enable and facilitate networked, automated, and brokered auctioning of document services. A plurality of processes are executed, including a customer process representing a customer, a supplier process representing a supplier, and a broker process capable of serving as an intermediary between the customer and supplier processes. The broker process is provided with a description of a document service. Responsively to the description thus provided, an auction for the document service is conducted, as follows: a customer or supplier process submits a bid for the document service; the broker process receives bidding information including the submitted bid; the broker process attempts to establish a price for the document service responsively to the received bidding information and, if a price can be established, establishes the price; if a price is established, the broker process proposes a transaction wherein the document service is to be provided at the established price; and if the proposed transaction is accepted, it can proceed automatically.

U.S. Pat. No. 6,041,308 discloses a system and method to enable and facilitate networked, automated, and brokered auctioning of document services. A plurality of processes are executed, including a customer process representing a customer, a supplier process representing a supplier, and a broker process capable of serving as an intermediary between the customer and supplier processes. The broker process is provided with a description of a document service. Responsively to the description thus provided, an auction for the document service is conducted, as follows: a customer or supplier process submits a bid for the document service; the broker process receives bidding information including the submitted bid; the broker process attempts to establish a price for the document service responsively to the received bidding information and, if a price can be established, establishes the price; if a price is established, the broker process proposes a transaction wherein the document service is to be provided at the established price; and if the proposed transaction is accepted, it can proceed automatically.

U.S. Pat. No. 6,047,266 discloses a system and method to enable and facilitate networked, automated, and brokered auctioning of document services. A plurality of processes are executed, including a customer process representing a customer, a supplier process representing a supplier, and a broker process capable of serving as an intermediary between the customer and supplier processes. The broker process is provided with a description of a document service. Responsively to the description thus provided, an auction for the document service is conducted, as follows: a customer or supplier process submits a bid for the document service; the broker process receives bidding information including the submitted bid; the broker process attempts to establish a price for the document service responsively to the received bidding information and, if a price can be established, establishes the price; if a price is established, the broker process proposes a transaction wherein the document service is to be provided at the established price; and if the proposed transaction is accepted, it can proceed automatically.

None of the prior art discloses a flexible marketing mechanism which enables users to bid competitively for provider services and/or goods, in short supply, and initiate changes in provider price, terms and conditions for the services and/or goods as market conditions warrant.

### SUMMARY OF THE INVENTION

User oriented services; e.g. telephone, theater, film, video, educational, etc. are often subject to excess demand with users expending considerable time without success in obtaining desired services due to an inflexible market mechanism in which users makes the same offer for services which the service provider accepts until the supply is exhausted. A flexible market based mechanism enables buyers to make competitive bids or offers to obtain services which otherwise would not be available due to excess demand and the mechanism selects the best bid or offer in behalf of the provider taking into account the provider's conditions and the user conditions. A coordinating server automatically manages a plurality of users in obtaining desired services from a plurality of service providers. The server is coupled to the users and the service provider(s) via a network, e.g. Internet, PSTN, Wireless, Cable, and Satellite. Each service provider maintains a queue of service requests or buyer offers in process. The service provider may also maintain multiple queues for priority service and/or lower levels of service. Each user service request is provided to the server, via the network, as a competitive bid for the desired service. The server interacts with the users requesting like services and conducts an auction in behalf of the service provider(s) changing the price, terms, conditions and availability of the service as the market demand warrants. Where the current price, terms, conditions for the service are beyond the users bid, the user bid may opt to be disconnected from the server. Alternatively, the user bid may request the service provider to call back or provide the user with an appointment for call back by the service provider. The server selects the user providing the best bid for entrance into the service provider queue and transmits to the winning user a token as evidence of the successful bid, after payment of the bid price to the server. The payment may be made by another on behalf of the winning user, provided the payer has a good standing with the server. The user presents the token to the service provider at the time the services become available, which may be in real time or the service may be downloaded to the user in the case of software, video, audio, etc. As one alternative, a user may offer the service provider a special payment to reduce the queuing time by being assigned to a priority queue. In another alternative, a lesser delivery of service may be made by the service provider at the option of the user or the service provider, which would entail a payment from the service provider to the user.

### BRIEF DESCRIPTION OF THE DRAWINGS

The invention will be further understood from a following detailed description of a preferred embodiment taken in conjunction with an appended drawing, in which:

FIG. 1 is a representation of a flexible marketing system incorporating the principles of the present invention for changing price, terms, conditions and availability of desired services or goods as market conditions warrant and calculating a service response to the requests for service or goods requests including rejection; alternate terms, conditions and price range or standard terms, conditions and price range.

FIG. 2 is a representation of a coordinating server in the system of FIG. 1.

FIG. 3A is a representation of an electronic template defining a service provider's standard terms and conditions for a service or goods.

FIG. 3B is an electronic template defining a user's offer for the provider's service or goods described in FIG. 3A.

FIGS. 4A, B and C are flow diagrams implementing the system of FIG. 1 using the server of FIG. 2 and the templates of FIGS. 3A and B.

### DETAILED DESCRIPTION OF THE PREFERRED EMBODIMENT

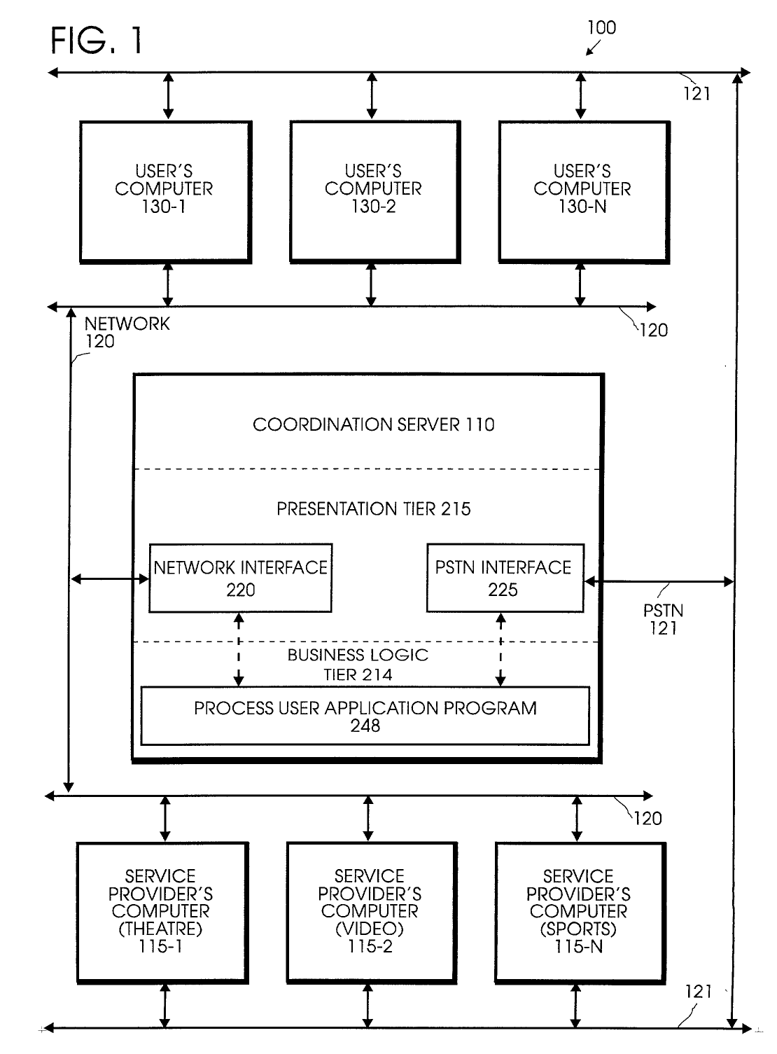

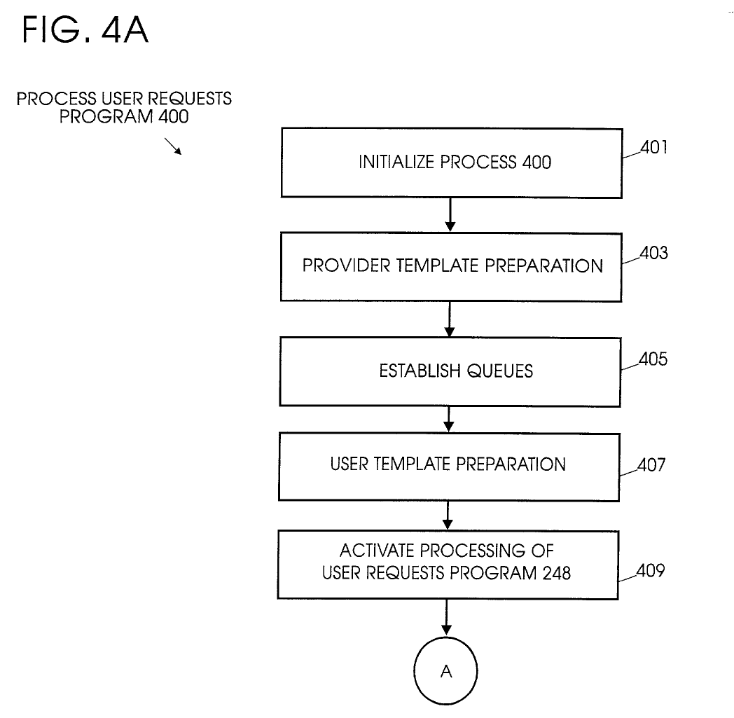

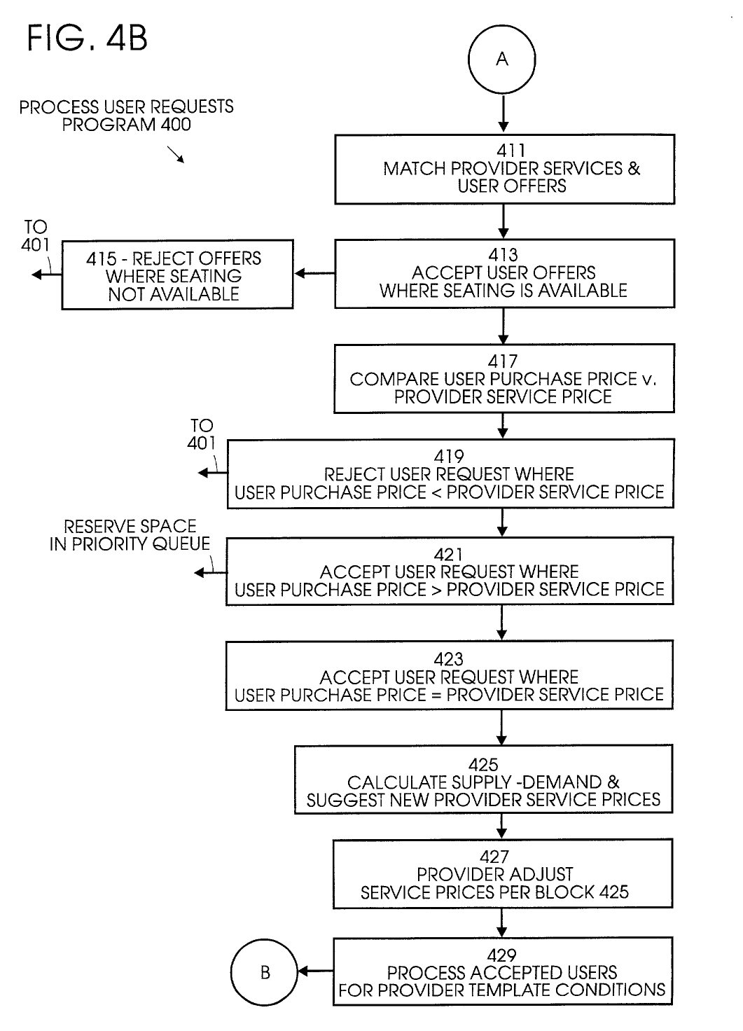

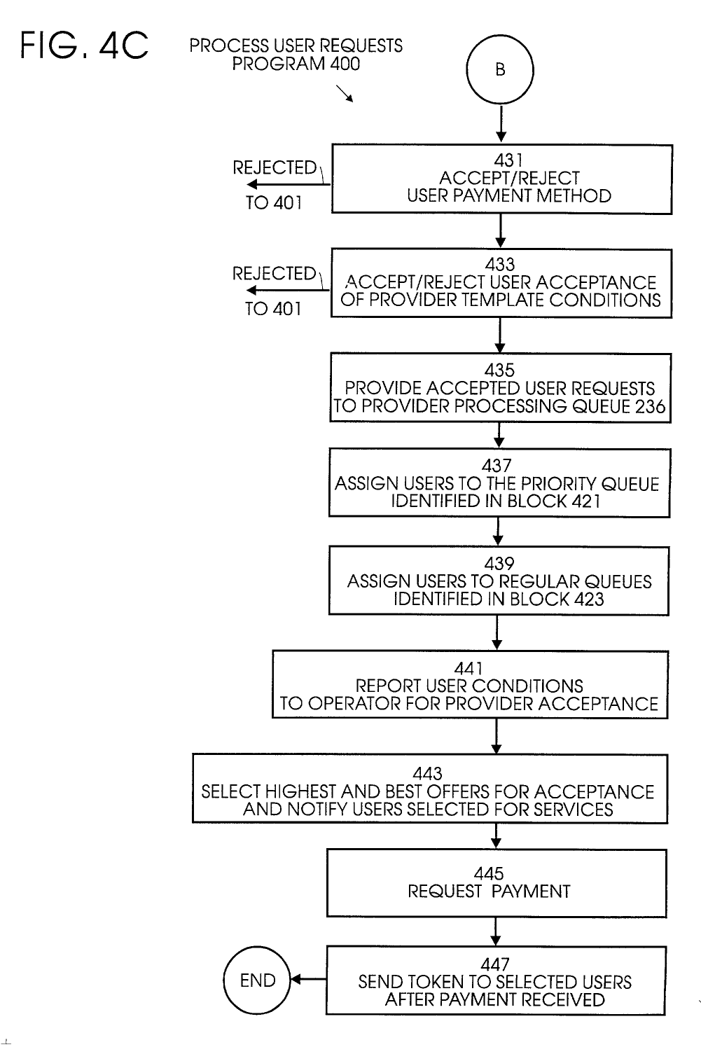

In FIG. 1 a flexible marketing system 100 includes a coordinating server 110 linked via a communications network 120, i.e., Internet or a telephone network, i.e. PSTN 121 to a plurality of Service Providers SP¹ . . . SPⁿ at terminals 115¹, 115² . . . 115ⁿ where, as for example, SP1 provides theatre services; SP2 provides films, video, etc; SP3 provides sports services. etc. In fact, any type of service or goods may be available from a provider and the examples chosen are only exemplary and not to be taken as limiting the invention. Each SP terminal includes queues 117 for storing accepted user requests after processing in FIGS. 4A, B and C to be described hereinafter. The server is further coupled through the communication networks 120, 121 via terminals 125¹ . . . 125ⁿ, 127¹ . . . 127ⁿ serving a plurality of User computers 130¹ . . . 130ⁿ. Typically, the users desire to obtain the services or goods with the least delay from the SPs where the demand for the service or goods may exceed the available supply. The function of the server is to automatically match the competitive offers from the Users to SP price, terms and conditions for the services or goods and select the user(s) with the best offer in terms of price and conditions to receive the services or goods at the least possible delay or at a desired user condition(s), e.g. scheduled time, place, seating, etc.

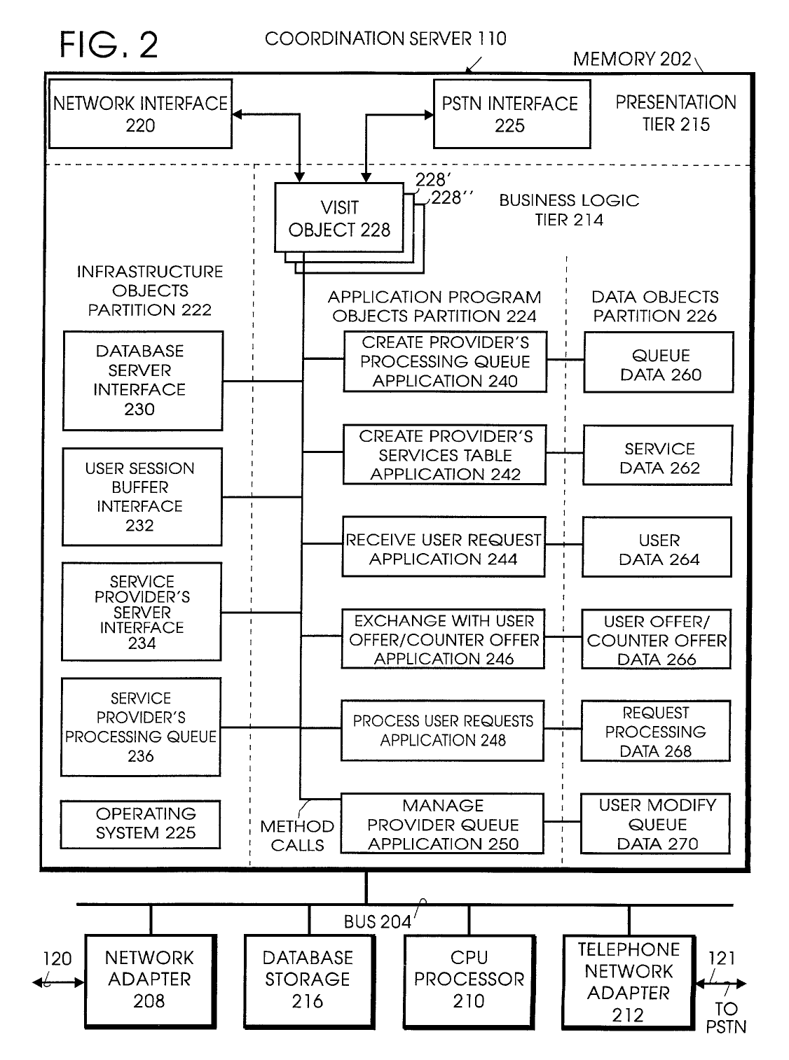

FIG. 2 discloses the coordination server 110 as comprising a memory 202 linked to a bus 204 serving a network adapter 208 coupled to the network 120; a CPU processor 210; a telephone network adapter 212 coupled to the network 120 and a data storage device 216.

The memory 202 is partitioned into a business logic tier 214, a presentation tier 215 and an infrastructure tier 222. The presentation tier 215 includes a standard network interface 220 linked to the adapter 208 for implementing the network protocols. Likewise a PSTN interface 225 is linked to the telephone adapter 212 for implementing the PSTN protocols. (1861003986).

The presentation tier object matches the graphical user interface with the User. A suitable implementation for the presentation tier 215 is with Java Servlets to interact with the provider or user using the hypertext transfer protocol (HTPP). The Java Servlets run within a request/response server, handling request managed messages from the provider/user and returning response messages to the provider/user. The Java Servlet is a Java object that takes a request as input, processes it's data, performs some logic, and then issues a response back to the provider/user. The Java Servlets are pooled and reused to service many requests. The Internet interface 220, implemented with Java Servlets, functions as a web server that communicates with the provider/user using the HTTP protocol. The interface 220 accepts HTTP requests from the provider/user and passes the information and request to the visit object 228 in the business logic tier 214. Result information returned from the logic tier 214 is passed by the visit object 228 to the Internet 220, which sends the results back to the provider/customer in an HTTP response. The interface 220 exchanges data through the Internet network adapter 208 with the provider/user.

The infrastructure object partition 222 provides the interfaces and the processing queues for server communications with the business logic tier 214 and user/provider interaction. A database server interface 230 enables the application programs 224 and the processor 210 to exchange data with the database storage 216 in a conventional manner. A user session buffer interfaces 232 hold user/server session communications for processing by the receiver. A server provider's server interface 234 links the server 110 to the provider terminal 115 (See FIG. 1) for communication purposes. A service provider's processing queue 236 stores the user requests processed by the application program 248, as will be described hereinafter. Multiple queues are provided to enable user requests to be assigned different priorities for receiving user services. A standard operating system 225 manages the processor 210 in automatically processing user requests for service using a flexible market based methodology.

The business logic tier includes multiple instances of a business visit object 228. A visit object program 228 interacts with the Internet interface 220 and the PSTN interface 225 in processing User requests for services and providing server responses to the requests in behalf of the respective SPs. The visit object program also interacts and services the business logic partition 214 and the infrastructure partition 222 in responding to the User requests in behalf of the SPs.

Briefly, the visit object 228 groups the various object-oriented software programs in the tiers into components which perform the major functions and application in the server 110. Enterprise Java Bean (EJB) is a software component architecture for servers, which is suitable for embodying the object oriented software program components of FIG. 2. A description of an e-commerce server programming application developed with Enterprise Java Bean is provided in the publication entitled “Mastering Enterprise Java Beans” by E. Roman, published by John Wiley & Sons, New York, N.Y., 1999. A description of use of an object model in the design of a web server for e commerce applications is provided in the text entitled “Beginning E Commerce”, by M. Reynolds, published by Wrox Press Inc., 2000 (ISPN 1861003986).

Each provider/user that sends a message to the server 100 has a temporary and separate business object 228 instantiated to represent the visit. The Enterprise Java B server can instantiate multiple copies of the business object component 228 in the business logic tier 214 to handle multiple messages from multiple provider/users. Each visit object 228 will buffer customer-specific information and maintain a customer-specific state for the duration of the session with the customer. Each visit object 228 is a stateful session bean that will hold the conversational state about the user's visit. A stateful session bean is an Enterprise Java Bean that services business processes that span multiple method requests or transactions. The stateful session bean retains state on behalf of an individual customer. Data received by the server from the customer and data sent by the server to the customer will be temporarily buffered in the visitor object 228.

When a message from a customer arrives at the server 100 and is received by the Internet interface 220 in FIG. 2, a visit object 228 is instantiated and the received data is passed to the visit object 228. Depending on the state of the transaction in the flow diagram of FIG. 2, the visit object 228 will send a method call to one of the object-oriented software program components in the application services object partition 224. If the transaction is that the customer has sent a user request application, then the customer's request is sent to the server 100. Then the visit object 228 will then send a method call to the RECEIVE USER REQUEST APPLICATION 244 in the server of FIG. 2. The visit object 228 will then pass the result data, such as an acknowledgement message, back to the Internet interface 220, which will send the result data back to the customer. Enterprise Java Beans support transaction processing, where a series of small operations are executed as one large, atomic operation. This allows multiple instantiations of the visitor object 228 representing multiple customers to share the same resource component, such as the RECEIVE USER REQUEST APPLICATION 244. When multiple calls are made on a method of the same resource component, the invocations are serialized and performed in lock step. Any accesses to the database 260 will be handled by the database server interface 230.

The logic tier 214 includes application program objects partition 224 including a create provider's processing queue application 240; a provider's services table 242; a received user's request application 244; a process user orders application 246; an exchange user offer/counter offer 246, and a managed providers queue application 250. Each of these applications is executed as required by the processor 210 when messages are received from the provider/user.

The create provider's processing queue application 240 receives user requests for services and stores them in a main queue or in one or more priority queues maintained in a queue data block 260 or at the provider's terminals 115, according to the provider's acceptance of the user's offer. The application also responds to the server in providing status and other information necessary stored in the queue data block 260 or at the provider terminal necessary for processing user service requests.

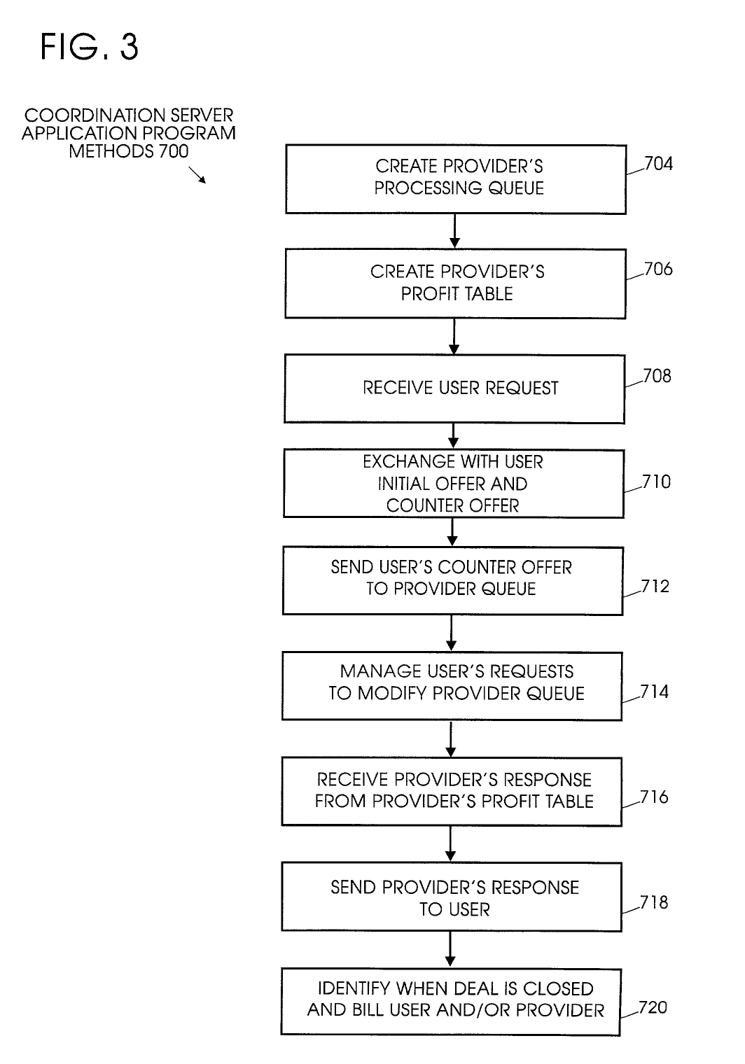

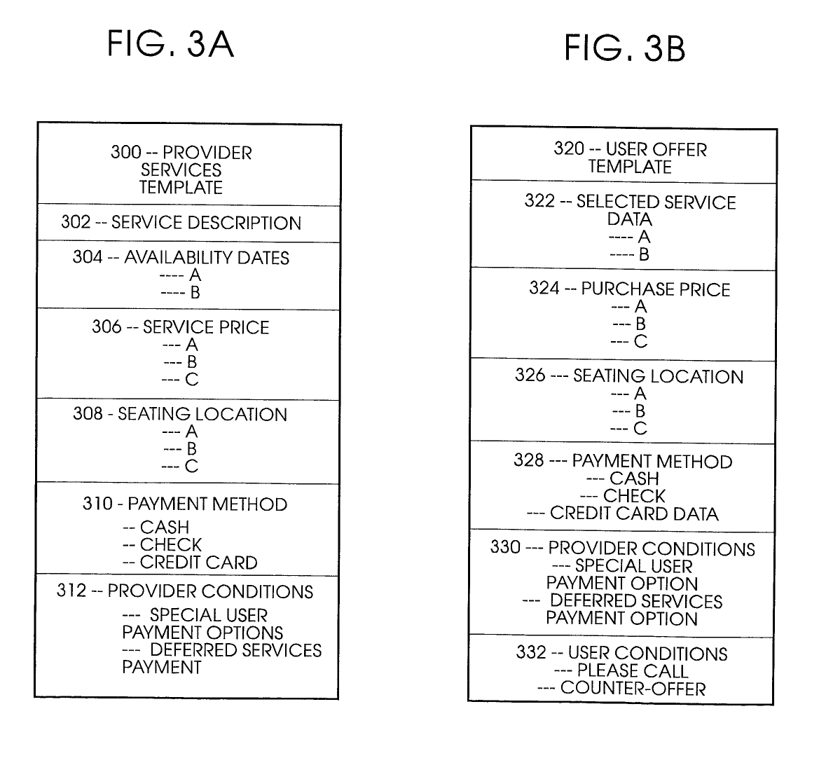

The create provider's services table application 242 creates and stores a table in service data block 262. The table describes the available provider services, charges, terms and condition taken from an electronic template (See FIG. 3A) prepared by the provider and translated into the table by the processor 210. The table is updated by new or updated electronic templates prepared by the provider as services, charges, terms and conditions change.

The receive user request application 244 receives and stores the user requests, in user data block 264. The user request data is taken from an electronic template (See FIG. 3B) created by the user in defining an offer or counter offer including a monetary amount and terms and conditions for the provider's services. The user data is updated by new or counter offers prepared by the users in electronic templates delivered to the server 110 and stored in block 266.

The exchange user offer/provider T/C's application 246 matches the user's templates for services in user data object 264 with the provider services tables in the service data block 262. The application compares corresponding categories in the user offer (FIG. 3B) and provider terms and conditions (FIG. 3A) for equal to, less than or greater than conditions and processes the results to select the best possible offer(s) for the services. The results are stored in a user offer/counter offer data block 266 for processing user requests in block 248, which will be described hereinafter.

A manage provider queue application block 250 alters the arrangement of the user requests in the Queue data block 270 according to the results of the processing block 248; selects the queue and location of the successful request in the queue and delivers a token to the successful user for presentation to the SP when the services or goods are to be delivered to the user by the SP.

The process user request block 248 interacts with the application blocks 240-246; automatically selects the successful user request application 248; notifies the user(s) of rejected offers; provides SP alternate terms and conditions to user in the event of multiple similar offers, and generates a supply—demand relationship for the services versus the user requests to calculate new suggested prices for the provider services using standard economic analysis. The application 248 will be described in more detail in conjunction with FIG. 4.

Before turning to the application 248 for processing user requests, a description will be provided of electronic templates for storing the provider's standard terms and conditions and the user's offer. The templates are electronic files created by the provider and the user that define attributes or values in categories for goods and services available from a provider and requested by a user. The categories vary according to the nature of the available goods and services, i.e. theater, sporting events, software, education and are determined by the provider. FIG. 3A shows an example of an electronic template 300 for provider services. The example chosen is for theatre tickets, but any services and/or goods can be described in a template by categories and the example chosen is not to be construed as limiting the scope of the invention. The template 300 includes a description 302 of the event; the period of availability 304; the price of the event 306 according to certain event specific conditions, e.g. eating location; specifics of the event 308, e.g. preferred condition; method of payment 310, e.g. check, credit card; time of payment and special conditions 312, e.g. priority seating surcharge; deferred request payment, etc. The special conditions indicated are only illustrative and may be replace or added to as market conditions warrant. The provider's terms and conditions are electronically signed and dated. The electronic template 300 is stored in the data objects block 260 for each service or goods available by the provider and used by the program 248 in processing user requests.

In FIG. 3B, a user template 320 presents an offer for the services in categories corresponding to the provider's categories. A selected date category 322 responds to the availability category 304. The user may enter an available or optional date in the selected date category. A purchase price category 324 responds to the price category 306. The user may enter a price related to the available or optional date and tie the date to different selected date or specific conditions. A seating category 326 responds to the category 308 and a user may designate selected seating and tie the seating to price. A payment category 328 corresponds to the payment category 310 and the user designates the method of payment. A special conditions category 330 responds to the category 312, as required by the provider. A user conditions category 332 indicates special user conditions, e.g. request for provider call back or a counter offer. The offer is electronically signed and dated by the user. User offers are stored in the data block 262 of the memory 202 and used by the program 248 in processing the user requests.

FIGS. 4A, B and C, taken in conjunction with FIGS. 1-3B, describes a process 400 executing the application program 248 in processing user requests for provider services or goods. In FIG. 4A, the system 100 is initialized in step 401. Each provider prepares an electronic template for available services and transmits them to the server in block 403 which receives, sorts and stores the standard terms and conditions in data object 262. The queue manager program 250 establishes queues for receiving offers for the various services established in block 405. Users obtain descriptions of provider services in block 407 and prepare templates for services responsive to the provider templates. The user templates are transmitted to the server, which stores them in data object 264. When a user service request or offer is received and stored in the data block 260, the process 248 is activated in block 409 to process the orders. The process 400 transfers to entry point A for processing of user requests.

In FIG. 4B, at entry point A, each request for services is sorted against available services in block 411. Requests for services outside the availability range are rejected in block 413 by sending a notice to the user via the visit object block 228. Service requests within the availability range are sorted by seating in block 415. The requests within the seating requests are accepted for further processing and matched against provider template price and seating in block 417. A user purchase price less than the provider template price is rejected in block 419, and a notice is sent to the user visit object 228. A user purchase price greater than the provider template price is accepted in block 421 for a priority queue subject to satisfaction of other provider categories. A user purchase price equal to the provider template price is accepted in block 423 subject to the availability of seating, after priority requests have been filled and the satisfaction of the other conditions. User seating or date conditions tied to the price are passed to an operator for acceptance or rejection. User conditions accepted by the operator are processed through the remaining provider template categories. User conditions rejected by the operator are returned to the user for submission of counter offers and stored in Block 266 for further processing. A flexible marketing mechanism in block 425 calculates changes in price, terms, conditions and availability of desired services or goods to the service provider templates 300 according to the number and type of offers received using standard economic supply-demand calculations. In block 427, the service provider changes the contents of the template categories according to the supply demand calculation in block 425. The users accepted in blocks 421 and 423 are identified for further processing in Block 429 and the process transfers to entry point B for processing of provider and user conditions.

In FIG. 4C, the special provider template conditions are compared to the user template conditions in block 431 and those offers accepting a payment method are processed for the other provider conditions 312 (See FIG. 3A) in block 433, while those offers not meeting the payment conditions are rejected and returned to the user. After the user requests have completed processing in block 433, the queue manage application 250 is alerted in block 435 for assignment of the users to one of the provider queues 117 which may be of several types. One provider queue may be for priority date and seating. Another provider queue may be for remaining available seating. Another provider queue may be for deferred services. In blocks 437 and 439, the queue manager application assigns the users to a queue according to their processing state. Users requesting special conditions or accepting special payments from the provider for deferred services are reported to an operator in block 441 for acceptance or rejection. In block 443, the user requests having the highest and best offer are accepted by the provider for priority services and thereafter other user request are accepted to the extent seating or other condition is available on their requested date. The accepted users are notified by a message including a description of the services, the date, seating and price. Where seating is not available, the offers are rejected and the user notified. In block 445 a request is made for payment. The message requests payment for the services by a selected date. Payments not received within the payment date are rejected and the user request is removed from the queue by the queue manage application 250 after notice by an operator. In block 447 a token is sent to the users making payment. The token can be a metallic, plastic, cardboard or the like member suitable for collection at the event. The token describes the specifics of the services, e.g. time date, seating, etc and is presented to the provider by the user at the time and date of the scheduled services after which the process ends.

While the invention has been described and shown in a preferred embodiment, various changes can be made therein without departing from the spirit and scope of the invention as defined in the following claims:

We claim:

1. A method for automatically processing user requests for services subject to excess demand using a flexible market based mechanism, comprising the steps of:
a) forming a network coupling a coordinating server to a plurality of service providers and a plurality of users seeking services from the service providers;
b) maintaining descriptions, price, terms and conditions for the available services from service providers;
c) preparing a user offer for desired services in terms of price, conditions and availability of the desired service to the user;
d) submitting the user offers to the coordinating server acting in behalf of the service provider;
e) comparing the user offers to the service provider descriptions, price, terms and conditions;
f) selecting the user offers matching the service descriptions and prioritizing the services for those user offers exceeding the provider price, terms and conditions for the desired service;
g) suggesting alternate provider price, terms and conditions; and
h) providing the selected user with a token for presentation to the service provider at the time of the after payment of the price.

2. The method of claim 1 further comprising the step of:
i) installing the selected users in the queue of the desired service provider.

3. The method of claim 1 further comprising the step of:
j) maintaining multiple queues by the service provider for different levels of service and/or priority of service requests.

4. The method of claim 1 further comprising the step of:
k) providing a special payment by the user to the service provider to assign the user to the priority queue.

5. The method of claim 1 further comprising the step of:
l) changing the level of service to the user at the option of the user or the service provider; and
m) making a payment to the user by the service provider for the reduced level of service.

6. The method of claim 1 further comprising the step of:
n) requesting a service provider call back or an appointment for a service provider call back by the user.

7. A system for automatically processing user requests for services subject to excess demand using a flexible market based mechanism, comprising:
a) means forming a network coupling a coordinating server to a plurality of service providers and a plurality of users seeking services from the service providers;
b) means maintaining descriptions, price, terms and conditions for the available services from service providers;
c) means preparing a user offer for desired services in terms of price, conditions and availability of the desired service to the user;
d) means submitting the user offers to the coordinating server acting in behalf of the service provider;
e) means comparing the user offers to the service provider descriptions, price, terms and conditions;
f) means selecting the user offers matching the service descriptions and prioritizing the services for those user offers exceeding the provider price, terms and conditions for the desired service;
g) means suggesting alternate provider price, terms and conditions; and
h) means provides the selected user with a token for presentation to the service provider at the time of the after payment of the price.

8. The system of claim 7 further comprising:
i) means installing the selected users in the queue of the desired service provider.

9. The system method of claim 7 further comprising:
j) means maintaining multiple queues by the service provider for different levels of service and/or priority of service requests.

10. The system of claim 7 further comprising:
k) means providing a special payment by the user to the service provider to assign the user to the priority queue.

11. The system of claim 7 further comprising:
l) means changing the level of service to the user at the option of the user or the service provider; and
m) making a payment to the user by the service provider for the reduced level of service.

12. The system of claim 11 where in the payment maybe in cash, credit or alternative compensation in terms of special services.

13. The system of claim 7 further comprising:
n) means requesting a service provider call back or an appointment for a service provider call back by the user.

14. A program medium executable in a computer system for automatically processing user requests for services subject to excess demand using a flexible market based mechanism, comprising:
a) program code in the medium forming a network coupling a coordinating server to a plurality of service providers and a plurality of users seeking services from the service providers;
b) program code in the medium maintaining descriptions, price, terms and conditions for the available services from service providers;
c) program code in the medium preparing a user offer for desired services in terms of price, conditions and availability of the desired service to the user;
d) program code in the medium submitting the user offers to the coordinating server acting in behalf of the service provider;
e) program code in the medium comparing the user offers to the service provider descriptions, price, terms and conditions;
f) program code in the medium selecting the user offers matching the service descriptions and prioritizing the services for those user offers exceeding the provider price, terms and conditions for the desired service;
g) program code in the medium suggesting alternate provider price, terms and conditions; and
h) program code in the medium providing the selected user with a token for presentation to the service provider at the time of the after payment of the price.

15. The program medium of claim 14 further comprising:
i) program code in the medium installing the selected users in the queue of the desired service provider.

16. The program medium of claim 14 further comprising:
j) program code in the medium maintaining multiple queues by the service provider for different levels of service and/or priority of service requests.

17. The program medium of claim 14 further comprising:
k) program code in the medium providing a special payment by the user to the service provider to assign the user to the priority queue.

18. The program medium of claim 14 further comprising:
l) program code in the medium changing the level of service to the user at the option of the user or the service provider; and
m) program code in the medium making a payment to the user by the service provider for the reduced level of service.

19. The program medium of claim 14 further comprising:
n) program code in the medium requesting a service provider call back or an appointment for a service provider call back by the user.
